(19) United States
(12) Patent Application Publication
(10) Pub. No.: US 2015/0154664 A1
(43) Pub. Date: Jun. 4, 2015

(54) AUTOMATED RECONCILIATION ANALYSIS MODEL

(71) Applicant: Fannie Mae, Washington, DC (US)

(72) Inventors: Zachary Dawson, Washington, DC (US); Rebecca Adler, Washington, DC (US); Patria S. Kunde, Washington, DC (US); John Treadwell, Washington, DC (US); Weifeng Wu, Washington, DC (US); Eric Rosenblatt, Washington, DC (US)

(73) Assignee: FANNIE MAE, Washington, DC (US)

(21) Appl. No.: 14/095,475

(22) Filed: Dec. 3, 2013

(51) Int. Cl. G06Q 30/02; G06Q 50/16

(52) U.S. Cl. CPC G06Q 30/0278; G06Q 50/16

(57) ABSTRACT

A device including a memory with an automated collateral fraud and risk detection application installed thereon, wherein the application determines whether a final appraised value of an appraisal was correctly reconciled from comparable properties listed on the appraisal by extracting reconciliation information from the appraisal, the reconciliation information including adjusted sale prices for each comparable property listed on the appraisal and the final appraised value; applying a rule set to the reconciliation information to generate sub-scores; applying a heuristic to the sub-scores to generate a reconciliation score; and outputting a scorecard for the appraisal based on the reconciliation score.

### BACKGROUND

One valuation method for a subject property is the sales comparison approach, which utilizes the sale of properties comparable to the subject property (comp(s)) to appraise the market value of the subject property. Particularly, in the sales comparison approach, comps are reconciled after adjustment into a single value indication (final appraised value) from the subject property. Yet the process of reconciling the results of selecting and adjusting comps possesses an inherent amount of subjectivity.

For example, when selecting comps that are the most similar to the subject property, differences between comps and subject property must be evaluated. The differences are evaluated across a multitude of factors that drive value within the subject property's market. The factors include the physical characteristics (e.g., living area, bedrooms, bathrooms, lot size), location characteristics (e.g., proximity to schools, parks, highways, shopping, specific feature), and additional characteristics (e.g., parking, outbuildings, porches, patios, decks, condition, view). Choosing which factors should drive market value is subjective, as some may place more weight on different factors. In turn, different comps may thus have higher market similarities to the subject property based on the chosen factors.

Next, the sale price of the selected comps are adjusted and reconciled into a final appraised value for the subject property. Comp adjustment is a manipulation of each comp's sale price in accordance with the alteration of comp factors to match the subject property. For example, if a subject property is 1,500 square feet, but a comp is 1,700 square feet, then the selling price of the comp should be adjusted downward to account for this difference in square feet. Reconciliation is a comparison of the adjusted sale prices to ensure an accurate market valuation of the subject property. Adjustment and reconciliation are also subjective, as some may place different weight on different adjustments and/or compare the results of the sale price adjustments differently.

In view of the above, it may be prudent to objectively analyze appraisal data to identify improper reconciliation due to subjectivity.

### BRIEF DESCRIPTION OF THE DRAWINGS

FIG. 1 illustrates an exemplary detection system which includes an automated collateral fraud and risk detection application;

FIG. 2 illustrates an exemplary process flow of an implementation of an automated collateral fraud and risk detection application; and

FIG. 3 illustrates an exemplary detection system in which automated collateral fraud and risk detection applications operate; and

FIG. 4 illustrates an exemplary process flow of an implementation of an automated collateral fraud and risk detection application.

### SUMMARY OF THE INVENTION

A system and method determines whether a final appraised value of an electronic appraisal was correctly reconciled from comparable properties listed on the electronic appraisal by extracting reconciliation information from the electronic appraisal, the reconciliation information including adjusted sale prices for each comparable property listed on the electronic appraisal and the final appraised value; applying a rule set to the reconciliation information to generate sub-scores; applying a heuristic to the sub-scores to generate a reconciliation score; and outputting a scorecard for the electronic appraisal based on the reconciliation score.

### DETAILED DESCRIPTION

A system and method determines whether a final appraised value of an electronic appraisal was correctly reconciled from comparable properties listed on the electronic appraisal.

For example, the system and method may via an automated collateral fraud and risk detection application evaluate improper reconciliation risks in an appraisal by determining whether a final appraised value reflects a value indicated by comparable properties. The determination may include applying a rule set to the appraisal to detect the presence of certain conditions in conjunction with a sub-score calculation per rule. The sub-scores resulting from the sub-score calculation may be inserted each into a heuristic that generates a reconciliation score indicating the probability that the appraisal was poorly reconciled.

An appraisal (e.g., a real estate appraisal, property valuation, or land valuation) may be a process of valuing real property, where the value sought is a market value. Different appraisal approaches may be employed to estimate market value when appraising real property, such as a sales comparison approach. The sales comparison approach is a substitution approach that values real property as comparable substitute properties are valued. In general, the sales comparison approach may include utilizing documentation (e.g., other appraisals) for sales of similar substitute properties (e.g., comparable properties or comps) in a comparative analysis of a subject property (e.g., real property being value). The comparative analysis outputs adjusted sale prices for each comp based on upward or downward adjustment of the actual sale price of the comp. The adjusted sale prices are then reconciled into a single value indication (e.g., final appraised value) intended to be the market value of the subject property. Appraisal reconciliation may thus be an objective weighing of one or more adjusted comp sale prices to arrive at a supportable, final appraised value (e.g., the appraised market value of subject property).

The appraisal may be recorded on a form, an example of which may be a uniform residential appraisal report form, that provides multiple sections with multiple data fields, each field containing data that may contribute to the final appraised value of the property. One section of the appraisal form may include a reconciliation section that records a final appraised value and evidence supporting the final appraised value. The form may be stored electronically and be referred to as an electronic appraisal.

In general, once an appraisal form is received by the automated collateral fraud and risk detection application, the application extracts the final appraised value and evidence supporting the final appraised value from the reconciliation section of the appraisal form along with comp information and applies a rule set to the extraction to generate sub-scores. A rule set is a combination of routines that detects the presence of certain conditions (e.g., particular reconciliation anomalies), where each routine may derive a rule value and apply at least one condition to the rule value to generate a sub-score.

Next, the automated collateral fraud and risk detection application executes a heuristic that utilizes as inputs the sub-scores to generate a reconciliation score, which indicates whether the appraisal form was poorly reconciled. The application then outputs a scorecard including rule set identifiers (e.g., indexes identifying which routines were included and applied by the rule set), corresponding sub-scores, and the reconciliation score for the appraisal form. The scores and sub-scores within the scorecard may be referred to as confidence metrics that indicate the quality of the reconciliation that produced final appraised value extracted from the appraisal form. Confidence metrics may be presented via an alpha-numerical scale, such as, a scale of 1 to 5, with 1 being an indicator of the highest quality and 5 being an indicator of the lowest quality).

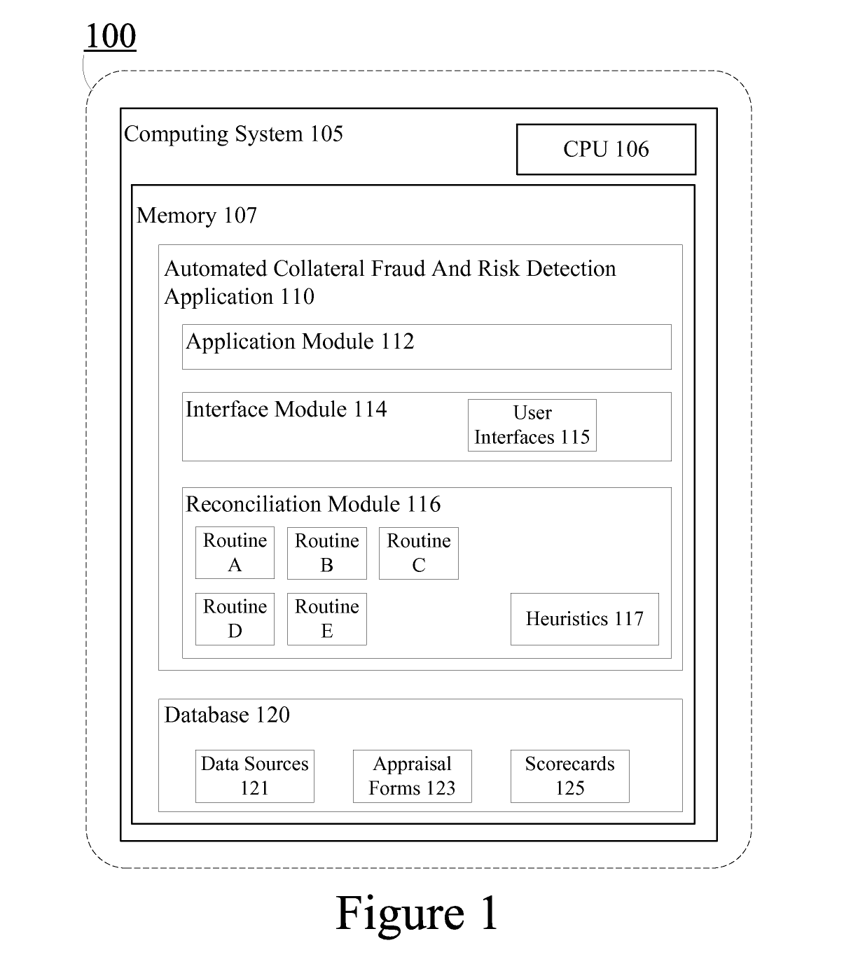

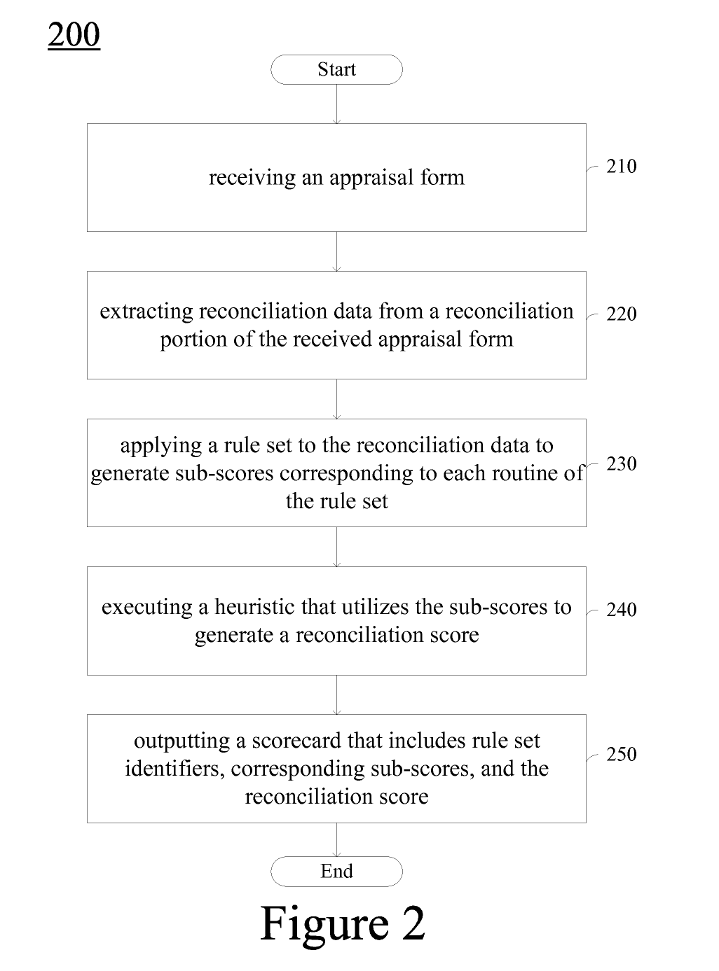

FIG. 1 illustrates an exemplary detection system 100 that includes a computing device 105 having a central processing unit (CPU) 106 and a memory 107 on which are stored an automated collateral fraud and risk detection application 110 (herein referred to as the application 110). The application 110 comprises an application module 112, an interface module 114 that generates user interfaces 115, a reconciliation module 116 that manages rule set (Routines A-E) and heuristics 117. The memory 107 further stores a database 120 that manages data sources 121, appraisal forms 123, and scorecards 125. In addition, although FIG. 2 illustrates one modular example of the application 110, where the modules may be software that when executed by the CPU 106 provides the operations described herein, the application 110 and its modules may also be provided as hardware or firmware, or combinations of software, hardware and/or firmware. And, although one example of the modularization of the application 110 is illustrated and described, it should be understood that the operations thereof may be provided by fewer, greater, differently named, or differently located modules (e.g., as illustrated in the Figures below).

The exemplary detection system 100 may utilize the computing device 105 and the application 110 to enable the reviewing and evaluation of appraisal forms 123. For example, the application 110 may acquire an appraisal form 123 (e.g., an electronic version of a real estate appraisal, property valuation, or land valuation as described above) via the application module 112 from the database 120. Further, the application 110 may utilize the Routines A-E and heuristics 117 of the reconciliation module 116 to evaluate risk in the reconciliation section of the appraisal form 123 in view of data sources 121. Based on the risk evaluation, the application may generate and store scorecards 125 within the database 120 that may later be accessed and presented by user interfaces 115 of the interface module 114 for subsequent review by end users.

The exemplary computing device 105 may be any computing system and/or device that include a processor and a memory (e.g. 106 and 107, respectively). In general, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing systems and/or devices generally include computer-executable instructions (e.g., application 110), where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc.

The exemplary detection system 100 and the exemplary computing device 105 may take many different forms and include multiple and/or alternate components and facilities, e.g., as illustrated in the Figures further described below. While exemplary systems are shown in the Figures, the exemplary components illustrated in the Figures are not intended to be limiting. Indeed, additional or alternative components and/or implementations may be used.

In general, a processor or a microprocessor (e.g., CPU 106) receives instructions from a memory (e.g., memory 107) and executes these instructions, thereby performing one or more processes, including one or more of the processes described herein. Such instructions and other data may be stored and transmitted using a variety of computer-readable mediums (e.g., memory 107). The CPU 106 may also include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the CPU 106 may be any one of, but not limited to single, dual, triple, or quad core processors (on one single chip), graphics processing units, visual processing units, and virtual processors.

The memory 107 may be, in general, any computer-readable medium (also referred to as a processor-readable medium) that may include any non-transitory (e.g., tangible) medium that participates in providing data (e.g., instructions) that may be read by a computer (e.g., by a CPU 106 of the computer device 105). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The application 110 may be software stored in the memory 107 of the computing device 105 that may be executed by the CPU 106 of the computing device 105 to perform one or more of the processes described herein, such as applying heuristics 117 stored on the reconciliation module 116 to rule values.

In general, the application 110 may be configured to evaluate risk in the reconciliation section of an appraisal form 123 to determine if the final appraised value appropriately reflects a value implied by comps listed on the appraisal form.

That is, the application 110 may be configured to acquire appraisal forms 123 from the database 120 via the application module 112; evaluate the acquired appraisal forms 123 via the Routines A-E and heuristics 117 of the reconciliation module 114; and generate scorecards 125 for the evaluated appraisal forms 123 that may be stored on the database 120 or presented through user interfaces 115 generated by the interface module 116. Further, the application module 112 may be configured to receive input, such as an appraisal form, via the user interfaces 115. The application module 112 may also acquire of retrieve a data file particular to an appraisal form stored on a database 120 or through to an external data source that provides the data files.

In addition, the application module 112 may include program code configured to facilitate communication between the modules of the application 110 and hardware/software components external to the application 110. For instance, the application module 112 may be configured to communicate directly with other applications, modules, models, devices, systems, and other sources through both physical and virtual interfaces. That is, the application module 112 may include program code and specifications for routines, data structures, object classes, and variables that receive, package, present, and transfer data through a connection or over a network, as further described below.

The interface module 114 may include program code for generating and managing user interfaces 115 that control and manipulate the application 110 based on a received input. For instance, the interface module 114 may be configured to generate, present, and provide one or more user interfaces 115 (e.g., in a menu, icon, tabular, map, or grid format) in connection with other modules for presenting information (e.g., scorecards 125) and receiving inputs (e.g., configuration adjustments, such as inputs altering, updating, or changing the Routines A-E and heuristics 117).

The user interfaces 115 described herein may be provided as software that when executed by the CPU 106 present and/or receive the information (e.g., data sources 121, appraisal forms 123, and scorecards 125). The user interfaces 115 may also include local, terminal, web-based, and mobile interfaces and any similar interface that presents and provides information relative to the application 110. The user interfaces 115 may also be provided as hardware or firmware, or combinations of software, hardware and/or firmware.

The reconciliation module 116 may be configured to store and operate a rule set, such as, Routines A-E) and heuristics 117 in support of analyzing risk in a reconciliation section of an appraisal form (e.g., detect whether certain conditions are present in an appraisal form and generates sub-scores for those conditions). One exemplary rule set may include a series of five routines that individually test the following conditions: (A) appraised value above comp adjusted range, (B) appraised value below comp adjusted range, (C) appraised value above comp unadjusted range, (D) appraised value below comp unadjusted range, and (E) comp pool does not adequately support value. Each routine generates a sub-score based on the conditions defined by the routine.

An ‘appraised value above comp adjusted range’ routine (Routine A) evaluates whether the final appraised value of the subject is higher than the adjusted sale price for the highest adjusted comp in the set of selected comps. For example, Routine A evaluates the final appraised value according to the following equation:

GAP=Appraised Value−max(Adjusted Comp Value), Equation 1:

where GAP (e.g., GAP value) is the difference between the final appraised value of the subject and the highest adjusted sale price, Appraised Value is the final appraised value of the subject, and max(Adjusted Comp Value) the highest adjusted sale price. In operation, the adjusted sale price of each selected comp is received by Equation 1 until the highest adjusted sale price is identified. Then the highest adjusted sale price is subtracted from the final appraised value to derive a GAP value. Routine A then applies a set of conditions to the GAP value to generate a sub-score. Table 1 is an example of a set of conditions that are utilized by Routine A to determine whether or not there was a reconciliation anomaly.

TABLE 1
Conditions Of Routine A

| Sub-score | Description |
|---|---|
| 1 | GAP ≦ $0 |
| 2 | GAP > $0 but less than $1000 |
| 4 | GAP > $1000 |
| 5 | GAP > $1000 and 5% of the Appraised Value |

An ‘appraised value below comp adjusted range’ routine (Routine B) evaluates whether the final appraised value of the subject is lower than the adjusted sale price for the lowest adjusted comp in the set of selected comps. For example, the ‘appraised value below comp adjusted range’ routine evaluates the final appraised value according to the following equation:

GAP=Appraised Value−min(Adjusted Comp Value), Equation 2:

where GAP (e.g., GAP value) is the difference between the final appraised value of the subject and the lowest adjusted sale price, Appraised Value is the final appraised value of the subject, and min(Adjusted Comp Value) the lowest adjusted sale price. In operation, the adjusted sale price of each selected comp is received by Equation 2 until the lowest adjusted sale price is identified. Then the lowest adjusted value is subtracted from the final appraised value to derive a GAP value. Routine B then applies a set of conditions to the GAP value to generate a sub-score. Table 2 is an example of a set of conditions that are utilized by Routine B to determine whether or not there was a reconciliation anomaly.

TABLE 2
Conditions Of Routine B

| Sub-score | Description |
|---|---|
| 1 | GAP ≧ $0 |
| 2 | GAP < $0, \|GAP\| < $1000 |
| 4 | GAP < $0, \|GAP\| ≧ $1000 |
| 5 | GAP < $0, \|GAP\| ≧ −$1000 and 5% of the Appraised Value |

Thus, Routine A and Routine B determine whether the final appraised value listed on the reconciliation portion of the appraisal form is within an adjusted range of the comps sale prices. The adjusted range is the field of values bounded by the lowest adjusted sale price and the highest adjusted sale price from the set of selected comps.

An ‘appraised value above comp unadjusted range’ routine (Routine C) evaluates whether the final appraised value of the subject is higher than the unadjusted value for the highest unadjusted comp in the set of selected comps. For example, Routine C evaluates the final appraised value according to the following equation:

GAP=Appraised Value−max(Unadjusted Comp Value), Equation 3:

where GAP (e.g., GAP value) is the difference between the final appraised value of the subject and the highest unadjusted sale price, Appraised Value is the final appraised value of the subject, and max(Unadjusted Comp Value) the highest unadjusted sale price. In operation, the unadjusted sale price of each selected comp is received by Equation 3 until the highest unadjusted sale price is identified. Then the highest unadjusted sale price is subtracted from the final appraised value to derive a GAP value. Routine C then applies a set of conditions to the GAP value to generate a sub-score. Table 3 is an example of a set of conditions that are utilized by Routine C to determine whether or not there was a reconciliation anomaly.

TABLE 3
Conditions Of Routine C

| Sub-score | Description |
|---|---|
| 1 | GAP ≦ $0 |
| 2 | GAP > $0 but less than $15000 or 5% of the Appraised Value |
| 3 | GAP > $15000 and 5% of the Appraised Value |
| 4 | GAP > $30000 and 10% of the Appraised Value |

Routine C differs from Routine A by comparing the final reconciled value to the range of raw sale prices for the selected comps rather than the comp sale prices after they have been adjusted toward the subject. Since being outside of an unadjusted range is more tolerable than being outside of the adjusted range, Equation 3 and Table 3 may be viewed as more lenient than Equation 1 and Table 1 of Routine A. The unadjusted range is the field of values bounded by the lowest unadjusted sale price and the highest unadjusted sale price from the set of selected comps. Further, although a final appraised value may be above an unadjusted range of comp sales prices, a final appraised value that is significantly higher may signal potential overvaluation.

An ‘appraised value below comp unadjusted range’ routine (Routine D) evaluates whether the final appraised value of the subject is lower than the unadjusted sale price for the lowest unadjusted comp in the set of selected comps. For example, Routine D evaluates the final appraised value according to the following equation:

GAP=Appraised Value−min(Unadjusted Comp Value), Equation 4:

where GAP (e.g., GAP value) is the difference between the final appraised value of the subject and the lowest unadjusted sale price, Appraised Value is the final appraised value of the subject, and min(Unadjusted Comp Value) the lowest adjusted sale price. In operation, the unadjusted sale price of each selected comp is received by Equation 4 until the lowest unadjusted sale price is identified. Then the lowest unadjusted sale price is subtracted from the final appraised value to derive a GAP value. Routine D then applies a set of conditions to the GAP value to generate a sub-score. Table 4 is an example of a set of conditions that are utilized by Routine D to determine whether or not there was a reconciliation anomaly.

TABLE 4
Conditions Of Routine D

| Sub-score | Description |
|---|---|
| 1 | GAP ≧ $0 |
| 2 | GAP < $0, \|GAP\| > $0 but less than $15000 or 5% of the |
| | Appraised Value |
| 4 | GAP < $0, \|GAP\| > $15000 and 5% of the Appraised Value |
| 5 | GAP < $0, \|GAP\| > $30000 and 10% of the Appraised Value |

Similar to Routine C, Routine D differs from Routine B by comparing the final reconciled value to the range of raw sale prices for the selected comps rather than the comp values after they have been adjusted toward the subject. Thus, Equation 4 and Table 4 may be viewed as more lenient than Equation 2 and Table 2 of Routine B. Further, although the final appraised value may be below the unadjusted range of comp sales prices, a final appraised value that is significantly lower could signal selection of superior comps to artificially inflate valuation. To assist in detecting false-positives, overvaluation, or artificial inflation, the logic for Routine C and D may be changed to exclude properties that are already flagged in as A or B and/or to a different percentage (e.g., the last condition of Routine D may be changed to: |GAP|>$30000 and 15% of the Appraised Value).

A ‘comp pool does not adequately support value’ routine (Routine E) detects whether a final appraised value was reconciled to a single highly valued comp, rather than a final appraised value that is supported by the entire set of selected comps. For example, Routine E outputs a sub-score based on detecting a violation and calculating the severity of the violation. A Routine E violation is when the final appraised value is within ±2% of the highest adjusted sale price and the second highest adjusted sale price is +15% less than the highest adjusted sale price. The severity of a Routing E violation is calculated according to the following equation:

GAP=Appraised Value−2nd highest adjusted comp value, Equation 5:

where GAP (e.g., GAP value) is the difference between the final appraised value of the subject and the second highest adjusted sale price, Appraised Value is the final appraised value of the subject, and 2nd highest adjusted comp value is the second highest adjusted sale price. Table 5 is an example of a set of conditions that are utilized by the Routine E to determine whether or not there was a reconciliation anomaly.

TABLE 5
Conditions Of Routine E

| Violation | Description |
|---|---|
| No | final appraised value ≧± 2% of the highest adjusted comp value or 2^{nd} highest |
| | Adjusted Comp Value ≧ 85% * highest Adjusted Comp Value |
| Yes | final appraised value <± 2% of the highest adjusted comp value and 2^{nd} highest |
| | Adjusted Comp Value < 85% * highest Adjusted Comp Value |
| Sub-score | Description |
| 1 | Violation = No |
| 4 | Violation = Yes and GAP ≦ $15k |
| 5 | Violation = Yes and GAP > $15k |

For example, if the subject was appraised at $295 k with Comp 1 having an adjusted value of $300 k and Comps 2 and 3 both having an adjusted value of $250 k, this would be a Routine E violation with a sub-score of 5.

The reconciliation module 116 may be configured to execute heuristics 117 that consumes the sub-scores to generate a reconciliation score. The heuristics 117 may be program code configured to generate probability estimations, flags, messages, and the like, including calculating a confidence metric (e.g., reconciliation score) based on the sub-scores produced by the routines. Reconciliation scores indicate whether the appraisal was poorly reconciled and may trigger further review of an appraisal or appraisal form by an end user when the heuristic 117 determines a threshold has been breached.

In one example, heuristic 117 derives a reconciliation score from the sub-scores generated by the Routines A-E via a maximum value heuristic (the heuristics 117 may also be a risk layering heuristic that might occur due to having multiple individual reconciliation violations). The maximum value heuristic identifies the worst or highest of the individual the sub-scores as the reconciliation score (e.g., a reconciliation score for an appraisal may be based on what is considered the worst violation for the appraisal). In this case, the maximum value heuristic identifies that the worst sub-score for is a sub-score of 4, as generated by Routine A. Thus, because the heuristics 117 may further utilize a threshold value to generate flags, which in this case is 2, and any appraisal form 123 with a reconciliation score equal to or greater than the threshold value is flagged for further review by an end user, the heuristic 117 would generate a flag for this particular sub-score. In other words, if the final appraised value of the subject property is outside of the adjusted range of the comps, the reconciliation module 116 will utilized Routines A-B to detect the outlying value and heuristic 117 to identify if the outlying value is severe enough to flag the appraisal form 123 listing the final appraised value as an elevated risk.

Therefore, the reconciliation module 116 may also provide flags, tokens, markers, messages, pop-ups, or the like, which identify the quality of an appraisal reconciliation as a poor through adequate. For instance, because the reconciliation module 116 generates a poor reconciliation score for a particular appraisal form 123, the reconciliation module 116 may automatically message an end user via the interface module 114 to review this acquisition for pricing adjustments or eligibility. The end user may in turn use the flagged appraisal form 123 to support decisions regarding the market value of the property.

The database 120 may include any type of data or file system (e.g., data sources 121, appraisal forms, and scorecards 125) that operates to support the application 110. For instance, data sources 121 may include appraisals and data sets relating to appraisal forms 123, along with documentation (e.g., underwriting submissions, underwriting approvals, loan documents, credit reports, and the like) relating to a property transaction, other data and/or business rules (e.g., secondary information), acquisitions, and/or any other data relating to or including borrower information, property address information, reported address information, credit report information (e.g., a set of credit reports), loan information, status information, etc. Appraisal forms 123 may be a set of at least one completed uniform residential appraisal report. Scorecards 125 may be a table for collecting and managing rule set identifiers, corresponding sub-scores, and the reconciliation score for the appraisal form.

The rule sets (e.g., Routines A-E), heuristics 117, data sources 121, appraisal forms 123, and scorecards 125 of the exemplary detection system 100 that support and enable the described operations may be stored locally, externally, separately, or any combination thereof. For example, the database 120 and its data may be provided as software stored on the memory 107 of computing device 105, while the user interface 115 may be provided as software within the interface module 114 and the Routines A-E and heuristics 117 may be provided as software within the reconciliation module 116 as shown. The database 120 may also be provided as hardware or firmware, or combinations of software, hardware and/or firmware.

In general, databases, data repositories or other data stores, such as database 120, described herein may include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within a computing system (e.g., computing device 105) employing a computer operating system such as one of those mentioned above, and are accessed via a network or connection in any one or more of a variety of manners. A file system (e.g., data sources 121, appraisal forms 123, and scorecards 125) may be accessible from a computer operating system, and may include files stored in various formats. An RDBMS generally employs the Structured Query Language (SQL) in addition to a language for creating, storing, editing, and executing stored procedures, such as the PL/SQL language mentioned above.

Further, in some examples, computing device 105 elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. In addition, the computing device 105 may take many different forms and include multiple and/or alternate components and facilities, e.g., as in the Figures further described below. While an exemplary computing device 105 is shown in FIG. 1, the exemplary components illustrated in the Figures are not intended to be limiting. Indeed, additional or alternative components and/or implementations may be used.

FIG. 2 illustrates an exemplary process flow 200 executed by an automated collateral fraud and risk detection application 110 to reconcile a final appraised value listed on an appraisal form 123.

In general, once an appraisal form 123 is received 210, the exemplary process flow 200 extracts 220 data from a reconciliation section of the received appraisal form 123 and applies 230 a rule set to the data to generate sub-scores. Next, the exemplary process flow 200 executes 240 a heuristic that utilizes the sub-scores to generate a reconciliation score. The exemplary process flow 200 then outputs 250 a scorecard 125 for the appraisal form that includes rule set identifiers, corresponding sub-scores, and the reconciliation score.

The exemplary process flow 200 will be described with reference to FIG. 2. The exemplary process flow 700 starts by the application 110 receiving 210 an appraisal form 123. One example of receiving 210 an appraisal form 123 includes receiving an input through a user interface 115 generated by the user interface module 114. The input may be a completed appraisal form 123 stored in a data file that is uploaded through the user interface 115. The input may also be individual data entries into the user interface 115 that receives and compiles the entries into a data set equating to a completed appraisal form 123.

Another example of receiving 210 the appraisal form 123 may include accessing and retrieving an appraisal form 123 from the database 120 or an external data source via the application module 112. Further, if the appraisal form 123 is stored in the database 120, the application module 112 may retrieve the related data from amongst the data sources 121.

Next, the application 110 extracts 220 reconciliation data in a reconciliation section of the appraisal form 123. To extract the reconciliation data, the application 110 may utilize data types, such as pointers, to reference a location within the appraisal form 123 in which reconciliation data may be obtained. In general, the reconciliation data may be found within the data fields of the reconciliation section and may include a set of selected comps, adjustments to the comps, indications of weight given to the adjustments, text field justifications for the weights, final appraisal value, etc. When the desired data is not found, the application 110 may walk or scan the remainder of the appraisal from to find the desired data. Thus, if adjusted and indicated values are not located within the reconciliation section, the application may utilize data types to reference the location of the adjusted and indicated values in other sections of the appraisal form 123.

With the reconciliation data extracted, the application 110 via the reconciliation module 116 applies 230 a rule set to the reconciliation data that generates sub-scores. In general, the rule set is a combination of routines that detects the presence of certain conditions (e.g., particular reconciliation anomalies), where each routine may derive a rule value and apply at least one condition to the rule value to generate a sub-score. In the case of the exemplary process flow 200, the application will apply Routines A-E, as described above, to a singular appraisal form 123 within database 120.

For instance, the reconciliation data may include three comparable properties, each of which include an unadjusted and adjusted sales price, unadjusted and adjusted ranges, and a final appraisal value for the subject as indicated in Table 6.

TABLE 6
Exemplary Reconciliation Data For Process Flow 200

| | Unadjusted | Adjusted |
|---|---|---|
| Comp 1 | $350,000 | $375,000 |
| Comp 2 | $400,000 | $395,000 |
| Comp 3 | $380,000 | $385,000 |
| | Lower Limit | Upper Limit |
| Unadjusted Range | $350,000 | $400,000 |
| Adjusted Range | $375,000 | $395,000 |

| | |
|---|---|
| Final Appraisal Valuation | $385,000 |

The reconciliation module 116 then determines the appraised value, maximum adjusted comp value, minimum adjusted comp value, maximum unadjusted comp value, minimum unadjusted comp value, and second highest adjusted comp value, such that the GAP value may be computed via the above equations 1-5. Accordingly, the Gap value for each equation is computed as follows:
Equation 1: −10,000=385,000-$395,000,
Equation 2: 10,000=385,000-$375,000,
Equation 3: −15,000=385,000-$400,000,
Equation 4: 25,000=385,000-$350,000, and
Equation 5: 0=385,000-$385,000.
   With each GAP value computed, the conditions of each Routine A-E are respectively applied to the corresponding GAP value, and each Routine A-E renders a sub-score. The exemplary results are found below in Table 7.

TABLE 7
Exemplary Sub-scores For Process Flow 200

| Routine | Sub-score | Adjusted |
|---|---|---|
| A | 1 | −$10,000 ≦ $0 |
| B | 1 | $10,000 ≧ $0 |
| C | 1 | −$15,000 ≦ $0 |
| D | 1 | $25,000 ≧ $0 |
| E | 1 | $0 ≧ $0 |

Next, the reconciliation module 116 executes 240 a heuristic 117 that utilizes as inputs at least the sub-scores to generate a reconciliation score for the singular appraisal. In this case, a maximum value heuristic that identifies the highest of the individual the sub-scores as the reconciliation score is applied to the set of sub-scores of Table 7. Because each Routine A-E rendered a sub-score of 1, the maximum value heuristic identifies that 1 is the highest sub-score and outputs a 1 as a reconciliation score for the appraisal form 123.

The exemplary process flow 200 then outputs 250 a scorecard 125 including rule set identifiers, corresponding sub-scores, and the reconciliation score. Outputting a scorecard 125 may include storing the scorecard 125 on the database 120 or presenting the scorecard 125 to an end user through a user interface 125. One example of a scorecard 125 includes Table 8 below, where the appraisal form 123 that was evaluated by the process flow 200 is identified by the appraisal number ‘123456’ in row two, the rule set identifies are the letters ‘A-E’ in column one, the corresponding sub-scores are number in column two, and the reconciliation score is identified as a ‘1’ in row eleven.

TABLE 8
Exemplary Scorecard

| Appraisal Form | 123456 |
|---|---|
| Routine | Sub-score |
| A | 1 |
| B | 1 |
| C | 1 |
| D | 1 |
| E | 1 |
| Reconciliation Score | 1 |

In addition, the application 110 may send a message to an end user that notifies an end user of the reconciliation status of the appraisal form 123 identified by the scorecard 125 (e.g., whether the appraisal was poorly reconciled). For instance, Table 9 includes exemplary messages that may be sent via an email or text message to an end user account based on a source routine for the reconciliation score (the routine that generated the highest sub-score), when the reconciliation score is greater than one.

TABLE 9
Exemplary Messages Relative To Routines A-B

| Source | | |
|---|---|---|
| Routine | SEARCH_TXT | MSG_TXT |
| A | Value estimate above range | The appraiser's value estimate is above the range of |
| | of adjusted comp values. | adjusted comparable values provided by the |
| | | appraiser. |
| B | Value estimate below range | The appraiser's value estimate is below the range of |
| | of adjusted comp values. | adjusted comparable values provided by the |
| | | appraiser. |
| C | Value estimate significantly | The appraiser's value estimate is significantly |
| | higher than comp sales | higher than the range of unadjusted comparable sales |
| | prices. | prices provided by the appraiser. |
| D | Value estimate significantly | The appraiser's value estimate is significantly lower |
| | lower than comp sales | than the range of unadjusted comparable sales |
| | prices. | prices provided by the appraiser. |
| V | Value estimate at or near | The appraiser's value estimate is at or near the |
| | maximum of adjusted comp | maximum adjusted comparable value with support |
| | values with support from | from only one comparable. |
| | only 1 sale. | |

Thus, in view of the above Table 9, when the exemplary process flow 200 outputs 250 a scorecard 125 that includes a reconciliation score of 2 that is based on a corresponding sub-score from Routine B the reconciliation module 116 may message an end user with the message “The appraiser's value estimate is below the range of adjusted comparable values provided by the appraiser.”

Next, the exemplary process flow 200 ends.

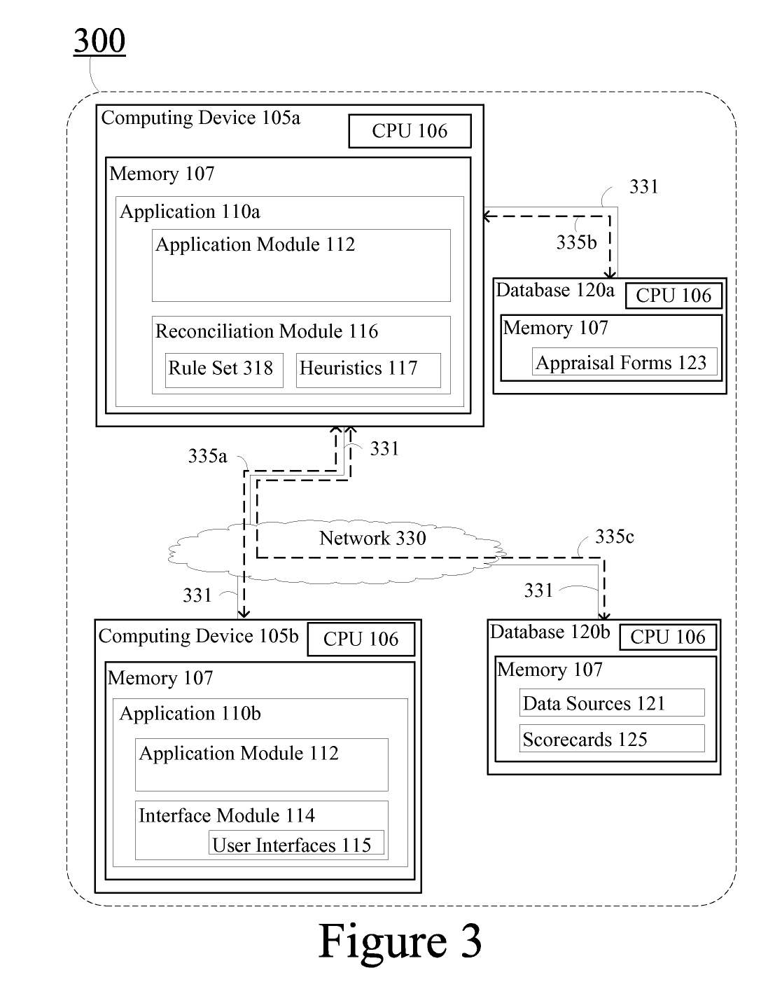

FIG. 3 illustrates an exemplary detection system 100 including multiple computing devices. For instance, the exemplary detection system 100 may include computing devices 105a-b and databases 120a-b, where each device and database includes a CPU 106 and a memory 107. In FIG. 3, the memory 107 of each device 105a-b respectively includes an application 110a-b installed thereon. The exemplary detection system 300 via the examples of applications 110a-b of the computing device 105a-b, which depicts a different modulation from the application 110, illustrates host and client applications operating in a web-, terminal-, or remote-based system. For instance, the applications 110a may be considered a host application modulated to supply heuristics 117 (and rule set 318) within reconciliation module 116. The applications 110b may be considered a client application that, in turn, may supply input to host application received via the user interfaces 115 generated by the interface module 114. For example, the client application may though a web interface submit and receive data to a host application.

Note that the same or equivalent elements as those of the FIG. 1 described above are denoted with similar reference numerals, and will not be described in detail with regard to FIG. 3. Thus, the rule set 318, the network 330, the physical connections 331, and virtual connection 335a-c of FIG. 3 will now be described.

Rule set 318 is an exemplary configurable combination of routines that detects the presence of certain conditions (e.g., particular reconciliation anomalies) on an appraisal form 123 and may be found in Table 10 as itemized below. Rule set 318 is a configurable combination of routines because through a user interface or other mechanism an end user may select routines from the rule set and/or add new routines to the rule set based on a desired detection of condition presence. Table 10 includes routine identifies in column one, routine titles in column two, and the operation description of each routine in column three.

TABLE 10
Exemplary Rule Set 318

| Routine | | |
|---|---|---|
| Identifier | Routine Title | Operation Description |
| A | Value estimate above adjusted | Maximum adjusted Comp sales price (within appraisal |
| | range of Comp sales prices | report) is $X Appraiser's value is $Y. Y >= X |
| B | Value estimate below adjusted | Minimum adjusted Comp sales price (within the |
| | range of Comp sales prices | report) is $X Appraiser's value is $Y. Y <= X |
| C | Value estimate significantly | Maximum unadjusted comp sales price (within the |
| | higher (10%+) than unadjusted | report) is $X Appraiser's opinion of value is $Y. |
| | range of Comp sales prices | Y >= (1.1 * X) |
| D | Value estimate significantly lower | Minimum unadjusted comp sales price (within the |
| | (10%+) than unadjusted range of | report) is $X Appraiser's opinion of value is $Y. |
| | Comp sales prices | Y <= (0.9 * X) |
| E | Appraiser putting all weight on | Max adjusted comp (within the report) = X. |
| | highest sale (within 1%) | Appraiser's value = Y. Y >= (.99 * X) |
| F | Value estimate significantly | Comp A (within the report) has minimum distance, |
| | higher (15%+) than unadjusted | most recent sale date, and lowest gross adjustments. |
| | value of best Comp | Unadjusted value of Comp A is $X. Appraiser's |
| | | opinion of value is $Y. |
| | | Y >= (1.15 * X) |
| G | Value estimate significantly | Comp A (within the report) has minimum distance, |
| | higher (10%+) than adjusted | most recent sale date, and lowest gross adjustments. |
| | value of best Comp | Adjusted value of Comp A is $X. Appraiser's opinion |
| | | of value is $Y. Y >= (1.1 * X) |
| H | Value estimate significantly | Comp A (within the report) total net adjustment is X. |
| | higher (5%+) than the qualitative | Comp A unadjusted value is Y. Appraiser's opinion of |
| | ceiling for our subject | value is Z. |
| | | X <= −2.5% |
| | | Z >= (1.05 * Y) |
| I | Wide range of adjusted comp | Min unadjusted value is X (within the report). Max |
| | sales prices with appraiser simply | unadjusted value (within the report) is Y. Average of X |
| | averaging (within 1% of average) | and Y = Z. Appraiser value is V. |
| | the adjusted comp values to arrive | (Y − X)/Z >= 0.3 |
| | at value conclusion | (0.99 * Z) <= V <= (1.1 * Z) |
| J | Value estimate significantly | Maximum adjusted value of active listings and/or |
| | higher than adjusted value of | pending sales (within the report) X. Appraiser's |
| | active listings. | estimate is Y. |
| | | Y >= (1.1 * X) |
| K | Value estimate significantly | Maximum unadjusted value of active listings and/or |
| | higher than unadjusted value of | pending sales (within the report) X. Appraiser's |
| | active listings. | estimate is Y. |
| | | Y >= (1.2 * X) |
| L | Value estimate significantly | Subject has X number of bedrooms. Maximum sales |
| | higher than maximum sales price | price of comps (within the report) that have X number |
| | for similar bedroom count | of bedrooms is Y. Appraiser's estimate is Z. |
| | | Z >= (1.1 * Y) |
| | | X < 3 |
| M | Value estimate significantly | Subject has X number of bedrooms. Maximum sales |
| | higher than maximum sales price | price of comps (according to model) that have X |
| | for similar bedroom count | number of bedrooms is Y. Appraiser's estimate is Z. |
| | | Z >= (1.1 * Y) and X < 3 |
| N | Value estimate significantly | Subject has only one full bathroom. Maximum sales |
| | higher than maximum sales price | price of comps (within the report) that have only one |
| | for similar bathroom count | full bathroom is Y. Appraiser's estimate is Z. |
| | | Z >= (1.1 * Y) |
| | | X = 1 |
| O | Value estimate significantly | Subject has only one full bathroom. Maximum sales |
| | higher than maximum sales price | price of comps (according to data sources) that have |
| | for similar bathroom count | only one full bathroom is Y. Appraiser's estimate is Z. |
| | | Z >= (1.1 * Y) and X = 1 |

Further, exemplary routines listed in Table 10 will now be described.

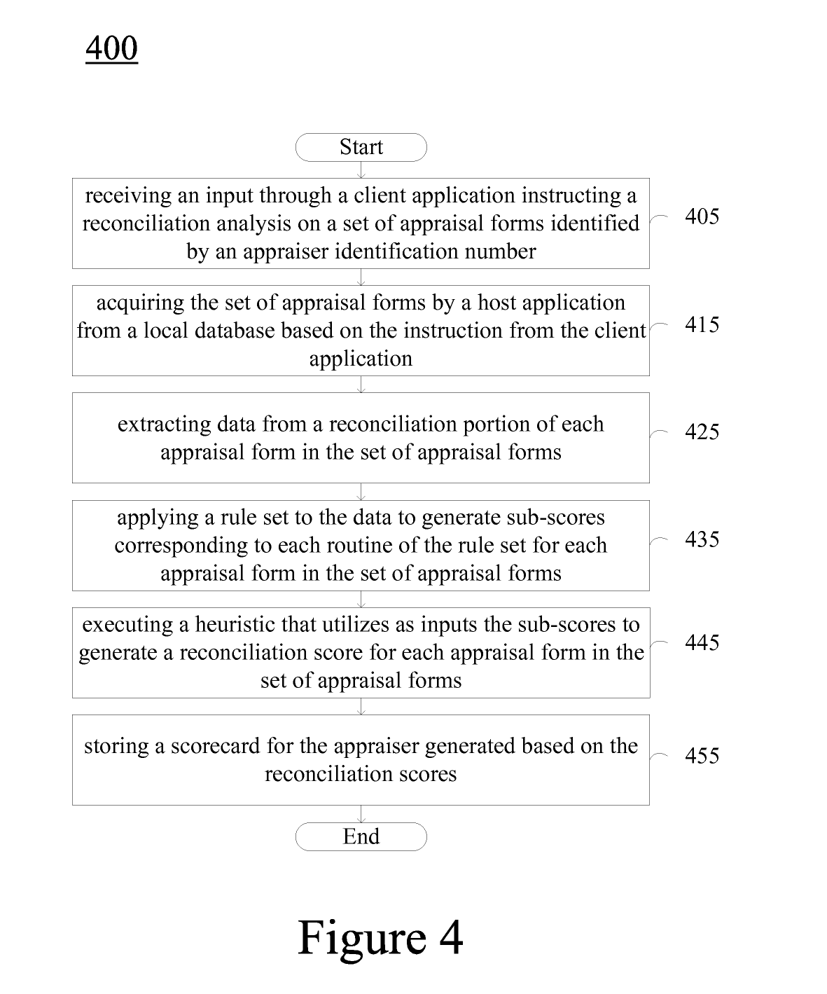

Exemplary Routine F relates to detecting a final appraised value that is higher (e.g., 15%+) than unadjusted sale price of best comp. In Exemplary Routine F, a flag is set for any arms-length (non-RE/Short Sale) comp that the appraiser has indicated is most proximate, most recent, and most similar. Note that the degree of difficulty may be higher in Exemplary Routine F than in other rules as this routine may be based on the appraiser's own information, rather than information stored within the appraisal form 123 or data sources 121. Further, explanation is provided with FIG. 4 description.

Exemplary Routine G relates to detecting a final appraised value that is higher (e.g., 10%+) than adjusted sale price of best comp. This logic is similar to Exemplary Routine F, but with the adjusted sale price of the comp.

Exemplary Routine H relates to detecting a final appraised value higher (e.g., 5%+) than the qualitative ceiling for the subject. In Exemplary Routine H, a flag is set for any non-REO/ShortSale comp that is noted by an appraiser to be measurably superior to the subject (e.g., negative total net adjustment may start at a −2.5% threshold). In general, the final appraised value should be qualitatively less than that comp sales price if the subject is truly inferior to that comp. But because the market is not perfect, a reasonable tolerance should be set to account for non-REO/ShortSale comp noise. Thus, REOs/ShortSale comps may be taken out because the terms of the transaction could be non-arms-length and give too many false positives. One option is to start the logic at 10%. Further, explanation is provided with FIG. 4 description.

Exemplary Routine I relates to detecting the existence of a wide range of adjusted comp sales prices in view of the appraiser simply averaging (e.g., within 1% of average) the adjusted comp values to arrive at the final appraised value. Appraisers should be employing a more sophisticated reconciliation process than simply averaging their adjusted values, particularly when there is a wide range of comp sale prices. For instance, appraisers can manipulate the adjusted range as easily as including 1 irrelevant comp or making unwarranted upwards adjustments to the high sale and then averaging the adjusted comp sales to arrive at a desired conclusion. Further, explanation is provided with FIG. 4 description.

Exemplary Routine J relates to detecting a final appraised value that is higher than adjusted value of active listings. While the principle of substitution would imply that the maximum value of a property would be determined by equally desirable substitute property, an appraiser's opinion of value should be in line with current market inventory. Thus, if market value is the most likely sales price at present time, it is irrational that the value would be significantly superior to current inventory of similar properties.

Exemplary Routine K relates to detecting a final appraised value that is higher than unadjusted value of active listings. Exemplary Routine K is similar to Exemplary Routine J; however, this routine accounts for potential over improvements. That is, the chances of subject selling for 20% more than “comparable” properties currently on the market (even after allowing for reasonable adjustments) are low and could be a sign of over-valuation.

Exemplary Routine L relates to detecting a final appraised value that is higher than maximum sales price for similar bedroom count. On studio, 1 bedroom, and 2 bedroom properties relevance of sales with higher bedroom count is questionable, for example, as buyers looking for a 2 bedroom home would not consider a 1 bedroom home. Appraisers may use comps with higher bedroom counts and subsequently higher utility out of necessity or as a way of inflating value. Either way, in the case of 0-2 bedroom homes, value should be reconciled with significant weight given to comps of similar utility.

Exemplary Routine M relates to detecting a final appraised value that is higher than maximum sales price for similar bedroom count. Exemplary Routine M is similar to Exemplary Routine L; however, this routine pulls maximum price from data sources and not from the actual appraisal itself.

Exemplary Routine N relates to detecting a final appraised value that is higher than maximum sales price for similar bathroom count. On properties with only one bathroom, relevance of sales with higher full bathroom count is questionable. Buyers looking for a 2 bathroom home (e.g., someone not wanting to share a bathroom with their children) would not consider a 1 bathroom home. It is also a well-known phenomenon that appraisers typically under adjust in these scenarios. Appraisers may use comps with higher bathroom counts and subsequently higher utility out of necessity or as a way of inflating value. Either way, in the case of 1 bathroom homes, value should be reconciled with significant weight given to comps of similar utility.

Exemplary Routine O relates to detecting a final appraised value that is higher than maximum sales price for similar bathroom count. Exemplary Routine O is similar to Exemplary Routine N; however, this routine pulls maximum price from data sources 121 and not from the actual appraisal itself.

A network 330 may provide the infrastructure through which the computing devices 105a-b and databases 120a-b communicate. The network 330 may be a collection of computers and other hardware to provide infrastructure to establish virtual connections and carry communications. For instance, the network 330 may be an infrastructure that generally includes edge, distribution, and core devices and provides a path for the exchange of information between different devices and systems (e.g., between the computer devices 105a-b). Further, the network 330 may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications between the computer devices 105a-b and the host and the client applications 110a-b.

Physical connections 331 may be wired or wireless connections between two endpoints (devices or systems) that carry electrical signals that facilitate virtual connections (e.g., transmission media including coaxial cables, copper wire, fiber optics, and the like). For instance, the physical connection 331 a may be a wired connection between computer devices 105a and database 120a, and the other physical connections 331 may be wired or wireless connections between computer devices 105a-b, database 120b, and routers on the edge of the network 330. Further, the physical connections 331 may be comprised of computers and other hardware that respectively connects endpoints as described.

Virtual connections 335 are comprised of the protocol infrastructure that enables communication to and from applications 110 and databases 120.

The exemplary detection system 300 and components thereof shown in FIG. 3 will now be described in detail with reference to the exemplary process flow 400 of FIG. 4.

The exemplary process flow 400 starts by the host application 110a receiving 405 via a virtual connection 335a from a client application 110b an input. The input, which was received through a user interface 115 of computing device 105b, includes an instruction for a reconciliation analysis of all appraisals associated with a particular appraiser. For instance, the input may include an appraiser identification number that is specific to the particular appraiser.

Next, in response to receiving the appraiser identification number, the host application 110a via the application module 112 acquires 415 through a virtual connection 335b the appraisal forms 123 based on the appraiser identification number from database 120a.

The host application 110a then via the reconciliation module 116 extracts 425 data (e.g., reconciliation information) in a reconciliation section of each appraisal form 123 associated with a particular appraiser. This data includes final appraisal values for each subject, unadjusted comp values, adjusted comp values, etc.

Next, the host application 110a via the reconciliation module 116 applies 435 a rule set 318 to the data to generate sub-scores corresponding to each routine of the rule set for each appraisal form 123. Table 12 describes some examples of routines from the rule set 318 in operation.

TABLE 11
Examples Based On Rule Set 318
Example “F”
Appraiser 987654 chooses 3 comps considered acceptable by typical standards. All are
proximate/recent. Adjustments not significant. Value reconciled towards the center of the adjusted
and unadjusted range of comp prices. However, by Appraiser 987654's own admission, C1 is the
closet/most recent/most similar (least adjustments). By all accounts, C1 is a reliable indicator of value
yet our estimate is 15% higher than the unadjusted sales price of C1.

| | C1 | | C2 | | C3 | | |
|---|---|---|---|---|---|---|---|
| Sales Price | $200,000 | | $230,000 | | $250,000 | | Final Value = $230,000 |
| Proximity | 0.1 | mile | .2 | mile | .3 | mile | |
| Sales Age | 30 | days | 60 | days | 45 | days | |

| | | | |
|---|---|---|---|
| Adjustments | $5,000 | −$5,000 | −$10,000 |
| Adjusted Price | $205,000 | $225,000 | $240,000 |

Example “H”
Appraiser 987654 chooses 3 comps from $300k-$350k all with downward adjustments, but none
significant as a % of property value. Appraiser 987654 reconciles just above the middle of the
adjusted range and in the middle of the adjusted/unadjusted range of values, perhaps not setting off
immediate red flags. However, when viewing qualitatively, Appraiser 987654 is implying C1 is
superior to our subject, yet reconciles the opinion of value 5% higher than C1. C2 is reported superior
to our subject, but Appraiser 987654 is concluding that market value is equal to this selling price.
This defies common sense, signaling poor methodology and perhaps over-valuation.

| | C1 | C2 | C3 | |
|---|---|---|---|---|
| Sales Price | $300,000 | $315,000 | $340,000 | Final Value = $315,000 |
| $ Adjustments | −$9,000 | −$10,000 | −$10,000 | |
| Total Net Adj % | −3.0% | −3.2% | −2.9% | |
| Adjusted Price | $291,000 | $305,000 | $330,000 | |

Example “I”
For sake of argument assume that C1 and C2 are most reliable indicators of value. C3 is either (a)
from superior location or (b) artificially inflated w/unsupported adjustments. Comp scoring and
adjustment scoring could be good based on strength of C1 and C2. Value would be bracketed by both
adjusted/unadjusted prices. Appraiser 987654 can still do damage in excess of 10% while flying
under the radar in some other capacities.

| Range | | | | AVG of | Avg | |
|---|---|---|---|---|---|---|
| (C1-C3) | C1* | C2* | C3* | 3 | 1 & 2 | Variance |
| 25% | $140,000 | $150,000 | $180,000 | $156,667 | $145,000 | 8% |
| 30% | $140,000 | $150,000 | $190,000 | $160,000 | $145,000 | 10% |
| 35% | $140,000 | $150,000 | $200,000 | $163,333 | $145,000 | 13% |

Example “K”
Subject is a 1 BR house. Appraiser 987654 utilizes combination of 1 and 2 BR comps and makes
typical - and perhaps understated - adjustment for second BR on C2/C3. Final reconciliation is within
the adjusted range of values. Knowing that a one bedroom will not attract buyers searching for 2
bedrooms, Appraiser 987654 should reconcile with considerable weight given to the only 1 BR comp.
It is highly unlikely that our subject is worth $165k when max value for a 1 BR is only $150k.

| | C1 | C2 | C3 | |
|---|---|---|---|---|
| Sales Price | $150,000 | $170,000 | $175,000 | Final Value = $165,000 |
| Bedrooms | 1 | 2 | 2 | |
| Adjustment | 0 | −5000 | −5000 | |
| Adjusted Price | $150,000 | $165,000 | $170,000 | |

*Adjusted comp values

The host application 110a via the reconciliation module 116 then executes 445 heuristics 117 that utilize as inputs the sub-scores to generate a reconciliation score for each appraisal form in the set of appraisal forms. For example, the reconciliation score for each appraisal form may be based on what is considered the worst violation for that appraisal, as identified by a maximum value heuristic.

Next, host application 110a generates and stores 455 a scorecard including the reconciliation scorecard via virtual connection 335c on database 120b. Table 12 is a sample score card that identified Appraiser 987654's history of possible improperly reconciled appraisal forms. For instance, 4 appraisal forms of the 529 form received a reconciliation score of 5, while 475 appraisal forms received a reconciliation score of 1.

TABLE 12
Sample Scorecard 125
Appraiser Identification Number: 987654

| Overall | | | | |
|---|---|---|---|---|
| Recon | | | Cumulative | Cumulative |
| Score | Frequency | Percent | Frequency | Percent |
| 1 | 475 | 89.79% | 475 | 89.79% |
| 2 | 35 | 6.62% | 510 | 96.41% |
| 3 | 10 | 1.89% | 520 | 98.30% |
| 4 | 5 | 0.95% | 525 | 99.24% |
| 5 | 4 | 0.76% | 529 | 100.00% |

The host application 110a may further transfer the risk evaluation as a result set to client application 110b for subsequent review through the user interfaces 115 of the interface module 114 by an end user.

Next, the exemplary process flow 400 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Further, for purposes of explanation, numerous details are set forth, such as flowcharts and system configurations, to provide an understanding of one or more embodiments. However, it is and will be apparent to one skilled in the art that these specific details are not required to practice the described.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method for automatically determining whether a final appraised value of an electronic appraisal was correctly reconciled from comparable properties listed on the electronic appraisal, the method comprising:
extracting, by a processing unit, reconciliation information from the electronic appraisal, the reconciliation information including adjusted sale prices for each comparable property listed on the electronic appraisal and the final appraised value;
applying, by the processing unit, a rule set to the reconciliation information to generate sub-scores;
applying, by the processing unit, a heuristic to the sub-scores to generate a reconciliation score; and
generating, by the processing unit, a scorecard for the electronic appraisal based on the reconciliation score.

2. The method of claim 1, wherein the rule set includes a plurality of configurable routines, each routine comprising an arithmetic equation and a condition table where a result value of the arithmetic equation is based on the reconciliation information and is utilized by the condition table to generate a sub-score.

3. The method of claim 2, wherein the plurality of configurable routines includes a routine that evaluates whether the final appraised value is higher than a highest adjusted sale price for an adjusted comparable property of the comparable properties listed on the electronic appraisal.

4. The method of claim 2, wherein the plurality of configurable routines includes a routine that evaluates whether the final appraised value is lower than a lowest adjusted sale price for an adjusted comparable property of the comparable properties listed on the electronic appraisal.

5. The method of claim 2, wherein the plurality of configurable routines includes a routine that evaluates whether the final appraised value is higher than a highest unadjusted sale price for an unadjusted comparable property of the comparable properties listed on the electronic appraisal.

6. The method of claim 2, wherein the plurality of configurable routines includes a routine that evaluates whether the final appraised value is lower than a lowest unadjusted sale price for an unadjusted comparable property of the comparable properties listed on the electronic appraisal.

7. The method of claim 2, wherein the plurality of configurable routines includes a routine that detects whether a final appraised value was reconciled to a single highly valued comparable property of the comparable properties listed on the electronic appraisal based on detecting a violation and calculating the severity of the violation.

8. The method of claim 7, wherein the violation includes when the final appraised value is within ±2% of a highest adjusted sale price of a comparable property of the comparable properties listed on the electronic appraisal.

9. The method of claim 1, wherein the heuristic is a maximum value heuristic that identifies the reconciliation score as a highest sub-score of the generated sub-scores.

10. The method of claim 1, wherein the heuristic generates a message when the reconciliation score is equal to or greater than a threshold value.

11. A non-transitory computer-readable medium tangibly embodying computer-executable instructions for automatically determining whether a final appraised value of an electronic appraisal was correctly reconciled from comparable properties listed on the electronic appraisal, the instructions when executed by a computer cause the computer to perform operations comprising:
extracting reconciliation information from the electronic appraisal, the reconciliation information including adjusted sale prices for each comparable property listed on the electronic appraisal and the final appraised value;
applying a rule set to the reconciliation information to generate sub-scores;
applying a heuristic to the sub-scores to generate a reconciliation score; and
generating a scorecard for the electronic appraisal based on the reconciliation score.

12. The medium of claim 11, wherein the rule set includes a plurality of configurable routines, each routine comprising an arithmetic equation and a condition table where a result value of the arithmetic equation is based on the reconciliation information and is utilized by the condition table to generate a sub-score.

13. The medium of claim 12, wherein the plurality of configurable routines includes a routine that evaluates whether the final appraised value is higher than a highest adjusted sale price for an adjusted comparable property of the comparable properties listed on the electronic appraisal.

14. The medium of claim 12, wherein the plurality of configurable routines includes a routine that evaluates whether the final appraised value is lower than a lowest adjusted sale price for an adjusted comparable property of the comparable properties listed on the electronic appraisal.

15. The medium of claim 12, wherein the plurality of configurable routines includes a routine that evaluates whether the final appraised value is higher than a highest unadjusted sale price for an unadjusted comparable property of the comparable properties listed on the electronic appraisal.

16. The medium of claim 12, wherein the plurality of configurable routines includes a routine that evaluates whether the final appraised value is lower than a lowest unadjusted sale price for an unadjusted comparable property of the comparable properties listed on the electronic appraisal.

17. The medium of claim 12, wherein the plurality of configurable routines includes a routine that detects whether a final appraised value was reconciled to a single highly valued comparable property of the comparable properties listed on the electronic appraisal based on detecting a violation and calculating the severity of the violation.

18. The medium of claim 17, wherein the violation includes when the final appraised value is within ±2% of a highest adjusted sale price of a comparable property of the comparable properties listed on the electronic appraisal.

19. A system configured to automatically determine whether a final appraised value of an electronic appraisal was correctly reconciled from comparable properties listed on the electronic appraisal, comprising:
a device including:
a processor; and
a memory, wherein the memory stores an automated collateral fraud and risk detection application executable by the processor to cause the processor to perform operations comprising:
extracting reconciliation information from the electronic appraisal, the reconciliation information including adjusted sale prices for each comparable property listed on the electronic appraisal and the final appraised value;
applying a rule set to the reconciliation information to generate sub-scores;
applying a heuristic to the sub-scores to generate a reconciliation score; and
generating a scorecard for the electronic appraisal based on the reconciliation score.

20. The system of claim 19, wherein the rule set includes a plurality of configurable routines, each routine comprising an arithmetic equation and a condition table where a result value of the arithmetic equation is based on the reconciliation information and is utilized by the condition table to generate a sub-score.
